(19) United States
(12) Patent Application Publication
(10) Pub. No.: US 2025/0047928 A1
(43) Pub. Date: Feb. 6, 2025

(54) AUTOMATED PACING OF VEHICLE OPERATOR CONTENT INTERACTION

(71) Applicant: Google LLC, Mountain View, CA (US)

(72) Inventors: Diego Jose Valenzuela Phillips, Kirkland, WA (US); Gregory Malcolm John Fitch, Sunnyvale, CA (US); Rachit Gupta, Kirkland, WA (US); Cristian Alcoholado Moenne, Kirkland, WA (US)

(21) Appl. No.: 18/363,588

(22) Filed: Aug. 1, 2023

(51) Int. Cl. H04N 21/414

(52) U.S. Cl. CPC H04N 21/41422

(57) ABSTRACT

In some examples, processors of an infotainment system receives a request to refresh a graphical user interface of the application being displayed by a display of the infotainment system. The processors determine whether the one or more processors received the request during a refresh limit period. Responsive to determining that the one or more processors received the request during a refresh limit period, the processors delay processing of the request. Responsive to expiration of the refresh limit period, the processors process the request, and, responsive to processing the request, initiate the refresh limit period.

### BACKGROUND

Operating a vehicle, such as an automobile, motorcycle, aircraft, marine craft, and the like, requires attention from the vehicle operator. Safe driving requires high levels of situational awareness of the driving task and of influences on the driving task. To maintain a high level of situational awareness for driving, the operator should pay attention to the road and be actively thinking about the driving task. When an operator engages in a secondary task, the operator may divert one or more of their eyes, hands, and mind away from the primary driving task. Diverting attention from the primary driving task too long or too frequently may result in dangerous driving behavior, and potentially cause a vehicle accident.

### SUMMARY

Techniques are described by which an infotainment system of a vehicle may use a refresh limit period to buffer the rate at which an application executing at the infotainment system refreshes a graphical user interface (GUI) of the application being displayed by the infotainment system. For example, the infotainment system may delay processing a request to refresh the GUI that is received during the refresh limit period until expiration of the refresh limit period. Responsive to expiration of the refresh limit period, the infotainment system may process the request and re-initiate the refresh limit period. In this way, the infotainment system may buffer the rate at which the application refreshes the GUI, which may reduce the frequency a vehicle operator diverts eyes from the primary driving task to look at the GUI. Additionally, the techniques of this disclosure may advantageously conserve computing resources of the vehicle (e.g., by processing fewer requests).

In some examples, a method includes receiving, by one or more processors of an infotainment system of a vehicle and from an application executing at the infotainment system, a request to refresh a graphical user interface of the application being displayed by a display of the infotainment system. The method further includes determining, by the one or more processors, whether the one or more processors received the request during a refresh limit period. The method further includes delaying, by the one or more processors, processing of the request in response to determining that the one or more processors received the request during a refresh limit period. The method further includes processing, by the one or more processors, the request in response expiration of the refresh limit period. The method further includes processing the request, initiating, by the one or more processors, the refresh limit period.

In some examples, an infotainment system of a vehicle includes one or more processors and a memory. The memory stores instructions that, when executed by the one or more processors, cause the one or more processors to receive, from an application executing at the infotainment system, a request to refresh a graphical user interface of the application being displayed by a display of the infotainment system. The instructions further cause the one or more processors to determine whether the one or more processors received the request during a refresh limit period. The instructions further cause the one or more processors to delay processing of the request in response to determining that the one or more processors received the request during a refresh limit period. The instructions further cause the one or more processors to process the request to in response to expiration of the refresh limit period. The instructions further cause the one or more processors to initiate the refresh limit period in response to processing the request.

In some examples, a non-transitory computer-readable storage medium includes instructions that, when executed, cause one or more processors to receive, from an application executing at the infotainment system, a request to refresh a graphical user interface of the application being displayed by a display of the infotainment system. The instructions further cause the one or more processors to determine whether the one or more processors received the request during a refresh limit period. The instructions further cause the one or more processors to delay processing of the request in response to determining that the one or more processors received the request during a refresh limit period. The instructions further cause the one or more processors to process the request to in response to expiration of the refresh limit period. The instructions further cause the one or more processors to initiate the refresh limit period in response to processing the request.

The details of one or more examples of the disclosure are set forth in the accompanying drawings and the description below. Other features, objects, and advantages will be apparent from the description and drawings, and from the claims.

### BRIEF DESCRIPTION OF DRAWINGS

FIG. 1 is a conceptual diagram illustrating an interior of a vehicle that includes a computing system configured to pace a rate at which a graphical user interface of a vehicle application refreshes, in accordance with one or more techniques of this disclosure.

FIG. 2 is a block diagram illustrating an example vehicle computing device configured to pace a rate at which a graphical user interface of a vehicle application refreshes, in accordance with one or more techniques of this disclosure.

FIG. 3 is a flow diagram illustrating another example operation of a computing device to pace a rate at which a graphical user interface of a vehicle application refreshes, in accordance with one or more techniques of the present disclosure.

### DETAILED DESCRIPTION

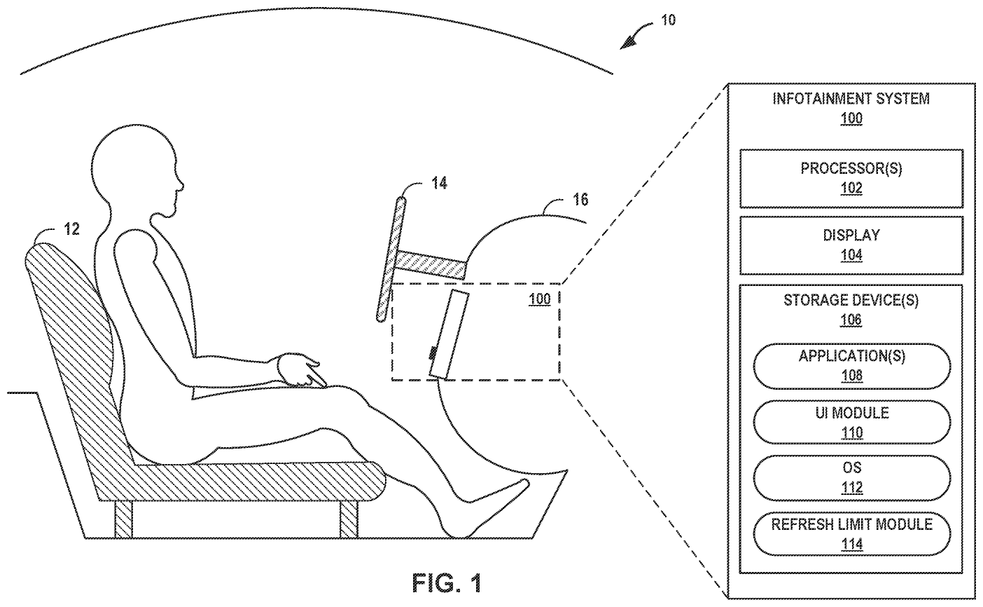

FIG. 1 is a conceptual diagram illustrating an interior of a vehicle that includes an infotainment system (which is an example of a vehicle head unit or may be otherwise referred to as a vehicle head unit) configured to pace a rate at which a graphical user interface (GUI) of a vehicle application refreshes, in accordance with one or more techniques of this disclosure. As illustrated in FIG. 1, a vehicle 10 includes a seat 12, a steering wheel 14, a dashboard 16, and an infotainment system 100. Vehicle 10 may be an automobile, but aspects of the present disclosure may also be applicable to other types of vehicles, including trucks, motorcycles, aircraft, watercraft, trains, bicycles, or other vehicles. A driver may normally occupy a seat 12, which may be positioned directly behind steering wheel 14 of vehicle 10 such that an occupant of seat 12 may physically control steering wheel 14. Steering wheel 14 may protrude from dashboard 16. At least one front passenger seat may be laterally positioned adjacent to seat 12. Other passenger seats may be positioned behind seat 12 or in front of seat 12.

A collection of devices, components, and modules that may each be included in infotainment system 100 is also shown in FIG. 1. Infotainment system 100 includes, but is not limited to, one or more processors 102 (“processor 102”), a presence-sensitive display 104 (“display 104”), and one or more storage devices 106 (“storage device 106”). One or more components of infotainment system 100, such as display 104 may be directly and physically accessible to occupants seated in the front driver and front passenger seats of vehicle 10, and may be located within, near, or on a center console. Such components may be within easy reach of such occupants, and may also or alternatively be positioned in another passenger area of vehicle 10, such as a back seat. In some examples, one or more components of infotainment system 100 that may not necessarily require physical access by occupants of vehicle 10 may be positioned in or on or integrated into dashboard 16.

Infotainment system 100 may operate to assist, inform, entertain, or perform other tasks that require user interactions with occupants of a vehicle. For example, storage device 106 of infotainment system 100 may include one or more application modules 108 (“application 108”) that perform functions or process information on behalf of one or more occupants of vehicle 10. For instance, infotainment system 100 may provide a navigation service that provides directions to destinations. Infotainment system 100 may also provide an information retrieval service that provides information in response to queries and/or as preemptive assistance or recommendations. Infotainment system 100 may also provide vehicle data about vehicle 10, or multimedia such as audio or video. Only a few examples are mentioned of the functionality that may be provided by infotainment system 100, and infotainment system 100 may provide many additional capabilities. In this and other ways, infotainment system 100 may improve the driving or riding experience for one or more occupants of vehicle 10.

Infotainment system 100 may include processor 102. Processor 102 may implement functionality and/or execute instructions within infotainment system 100. Examples of processor 102 include, but are not limited to, one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein.

In some examples, infotainment system 100 may be controlled through input detected by display 104, and/or through input detected by one or more additional input devices (e.g., microphones, cameras, physical buttons or switches, or other types of input devices). Display 104 may, in some examples, function simply as an input device for touch input, provided by user input that occurs directly and physically at display 104. For instance, display 104 may function as a presence-sensitive input device using a presence-sensitive device, such as a resistive touchscreen or touch panel, a surface acoustic wave touchscreen or touch panel, a capacitive touchscreen or touch panel, a projective capacitance touchscreen or touch panel, a pressure-sensitive screen or touch panel, an acoustic pulse recognition touchscreen or touch panel, or another presence-sensitive screen or touch panel technology.

Display 104 may function as an output device, such as a display device, using any one or more of a liquid crystal display (LCD), dot matrix display, light emitting diode (LED) display, organic light-emitting diode (OLED) display, e-ink, or similar monochrome or color display capable of outputting visible information to a user or vehicle occupant. In some examples, display 104 may also function as an input device, so that it serves as both an input and output device. In such examples, display 104 may include an integrated presence-sensitive input device (e.g., display 104 may be integrated into display 104) and a display device. For instance, display 104 may function as a presence-sensitive input device using a presence-sensitive screen, such as a resistive touchscreen, a surface acoustic wave touchscreen, a capacitive touchscreen, a projective capacitance touchscreen, a pressure-sensitive screen, an acoustic pulse recognition touchscreen, or another presence-sensitive screen technology. Based on user input, display 104 may present output to a user. For instance, display 104 may present various user interfaces of application 108 (e.g., a navigation application, a music application, a vehicle control application, a telephony application, a messaging application, a search application, etc.) executing at infotainment system 100. An occupant of the vehicle, such as a driver, may provide user input to interact with application 108.

Application 108 may include functionality to perform any variety of operations on infotainment system 100. For instance, application 108 may include one or more of a navigation application, a weather application, a phone dialer application, an information retrieval application, a multimedia application, a vehicle information application, an email application, a text messaging application, an instant messaging application, a social networking application, a stock market application, an emergency alert application, a sports application, to name only a few examples.

Storage device 106 may include a user interface (UI) module 110. UI module 110 may manage user interactions with display 104 and other components of infotainment system 100. For example, UI module 110 may output a UI, such as a GUI, and may cause display 104 to display the UI as a vehicle operator views output and/or provides input at display 104 or other components of infotainment system 100. In some examples, UI module 110 may be a part of an operating system (OS) 112 of infotainment system 100.

Vehicle 10 may include a wide variety of sensors, which may be configured to provide output to infotainment system 100. For instance, vehicle 10 may include a speed sensor, an acceleration sensor, a position sensor (e.g., a gear transmission position sensor), and the like. In some examples, infotainment system 100 may be configured to communicate with the sensors via a network or bus of vehicle 10, such as a component area network (CAN) bus.

In general, application 108 may display (e.g., via UI module 110 and display 104) dynamic data that can change over time. For example, application 108 (e.g., a weather application, a stock market application, a social networking application, a news application, a sports application, etc.) may fetch and display updated data at a certain frequency (e.g., to ensure that the displayed information is up to date). In so doing, application 108 may periodically refresh a GUI being displayed by display 104. However, if the GUI refreshes too frequently, the refreshing may introduce excessive visual changes and animations, which can distract a driver from the primary driving task. In turn, the risk of accidents may increase.

In accordance with one or more techniques of this disclosure, infotainment system 100 may use a refresh limit module 114 to pace application refresh frequency. For example, refresh limit module 114 may initiate a refresh limit period during which processor 102 delays (e.g., queues, but does not process) a request from application 108 to refresh a GUI. Responsive to expiration of the refresh limit period, UI module 110 may process the request, and responsive to UI module 110 processing the request, refresh limit module 114 may re-initiate the refresh limit period. In this way, infotainment system 100 may buffer the rate at which application 108 refreshes the GUI, which may reduce the frequency a vehicle operator diverts eyes from the primary driving task to look at the GUI. Additionally, the techniques of this disclosure may advantageously conserve computing resources of the vehicle (e.g., by processing fewer requests, resulting in lower processor and memory usage).

Application 108 may send UI module 110 a request to refresh at least a portion of a GUI of application 108 being displayed by display 104. Refresh limit module 114 may receive and manage the request from application 108 to reduce the likelihood of application 108 inappropriately distracting the driver of vehicle 10. For example, refresh limit module 114 may initiate a refresh limit period during which UI module 110 cannot process the request. As used herein, “initiate” may refer to a first initiation of a refresh limit period and/or subsequent initiations of a refresh limit period (e.g., a re-initiation).

Refresh limit module 114 may initiate a refresh limit period based on a variety of factors. As one example, refresh limit module 114 may initiate the refresh limit period in response to UI module 110 processing a request to refresh the GUI from application 108. Thus, the refresh limit period may act as a cooldown period between requests from application 108 to pace the frequency at which UI module 110 processes requests from application 108. In some examples, the refresh limit period may be ten seconds (though other durations, such as three second, five seconds, twelve seconds, etc., are contemplated by this disclosure).

Refresh limit module 114 may determine whether refresh limit module 114 received the request from application 108 during a refresh limit period. Responsive to determining that refresh limit module 114 received the request during the refresh limit period, refresh limit module 114 may delay processing the request until the expiration of the refresh limit period. Responsive to expiration of the refresh limit period, refresh limit module 114 may cause UI module 110 to process the request. Responsive to UI module 110 processing the request, refresh limit module 114 may initiate the refresh limit period (restarting the process).

While pacing requests from application 108 is important, it may be desirable in some circumstances for refresh limit module 114 to cause UI module 110 to process a request from application 108 even if refresh limit module 114 received the request during the refresh limit period. For example, when a driver interacts with application 108, the driver may initiate the request to refresh the GUI from application 108. If the GUI of application 108 does not refresh within a reasonable amount of time (e.g., a couple of seconds), the driver may believe application 108 is not functioning correctly and divert more attention from the primary driving task (e.g., to fix application 108).

Accordingly, refresh limit module 114 may determine whether a request to refresh the GUI from application 108 is user-initiated. For example, refresh limit module 114 may determine that the request is user-initiated based on whether a user input (e.g., tapping a button, making a gesture, saying a voice command, etc.) caused application 108 to send the request. Responsive to determining that refresh limit module 114 received the request during the refresh limit period and that the request is not user-initiated, refresh limit module 114 may delay the request until the expiration of the refresh limit period. Responsive to determining that the request is user-initiated, refresh limit module 114 may cause UI module 110 to process the request irrespective of whether there is an ongoing refresh limit period. That said, responsive to UI module 110 processing the request, refresh limit module 114 may initiate the refresh limit period (such that any ongoing refresh limit period restarts).

Another circumstance in which pacing application refresh may be undesirable is when vehicle 10 is in a stationary state, (e.g., parked, not moving, etc.). For example, when vehicle 10 is in a stationary parked, the driver may not have a primary driving task to perform such that application 108 cannot distract the driver from the primary driving task in the first place. In other words, when vehicle 10 is in a stationary state, the driver may have reduced responsibilities related to navigation, traffic monitoring, and vehicle control, giving the driver greater capacity to engage with application 108 without compromising safety.

As such, refresh limit module 114 may determine whether vehicle 10 is in a stationary state when refresh limit module 114 receives a request to refresh the GUI from application 108. For example, refresh limit module 114 may (e.g., via OS 112) determine that vehicle 10 is parked based on indications received from in-vehicle systems and/or from sensors of infotainment system 100 (e.g., physical wheel speed, a global positioning system (GPS), etc.). For example, components of vehicle 10 may detect when vehicle 10 is in a “Park” setting or gear, and refresh limit module 114 may receive an indication of the setting/gear from the components. In any case, responsive to determining that vehicle 10 is not in a stationary state, refresh limit module 114 may delay the request until the expiration of the refresh limit period. Responsive to determining that vehicle 10 is in a stationary state, refresh limit module 114 may cause UI module 110 to process the request irrespective of whether there is an ongoing refresh limit period. Furthermore, refresh limit module 114 may not initiate a refresh limit period while vehicle 10 is in a stationary state. Thus, refresh limit module 114 may not buffer the requests from application 108 while vehicle 10 is in a stationary state.

The techniques of this disclosure may serve to decrease a distraction level of a vehicle operator while still enabling usage of application 108. In this way, the techniques of this disclosure may avoid the implementation of more stringent attention management systems (e.g., systems that terminate application 108 based on a number of refreshes), which may be less practical and user-friendly. Additionally, the techniques of this disclosure may further conserve computing resources of infotainment system 100.

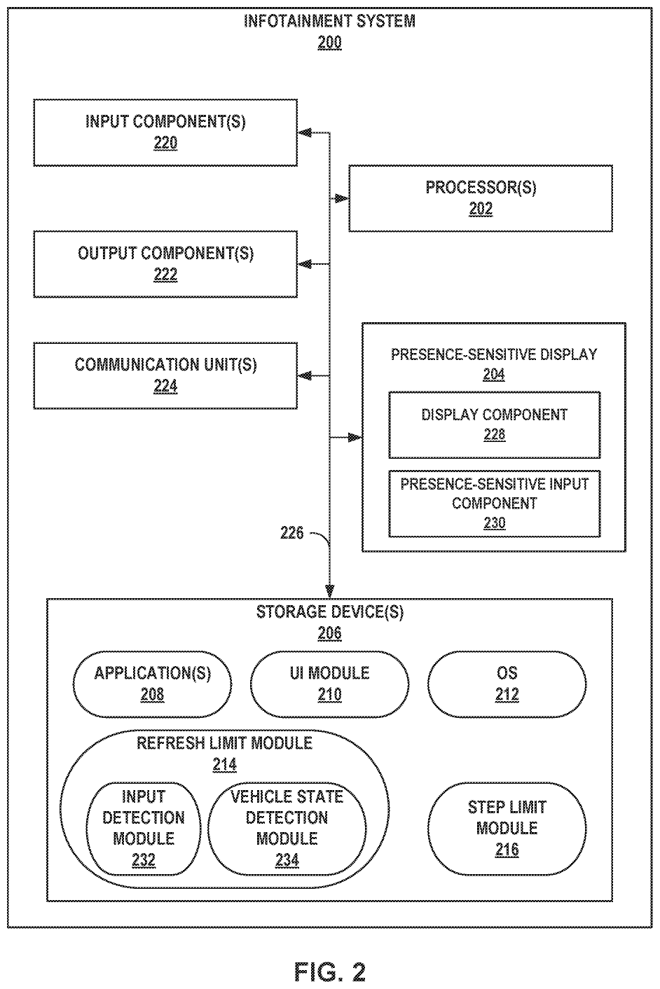

FIG. 2 is a block diagram illustrating an infotainment system 200 (which is an example of a vehicle head unit or may be otherwise referred to as a vehicle head unit) configured to pace a rate at which a GUI of a vehicle application refreshes, in accordance with one or more techniques of this disclosure. Infotainment system 200 shown in the example of FIG. 2 is one example of infotainment system 100 shown in FIG. 1. FIG. 2 illustrates only one particular example of infotainment system 200, and many other examples of infotainment system 200 may be used in other instances and may include a subset of the components included in example infotainment system 200 or may include additional components not shown in FIG. 2.

As shown in the example of FIG. 2, infotainment system 200 includes one or more processors 202, a presence-sensitive display 204 (“display 204”), one or more storage device 206 (“storage device 206”), one or more input components 220, one or more output components 222, one or more communication units 224. Storage device 206 may include one or more application modules 208 (“application 208”), a UI module 210, a refresh limit module 214, an OS 212, and a step limit module 216. Communication channels 226 may interconnect one or more of the components infotainment system 200 for inter-component communications (physically, communicatively, and/or operatively). In some examples, communication channels 226 may include a system bus, a network connection, one or more inter-process communication data structures, or any other components for communicating data between hardware and/or software.

As shown in FIG. 2, infotainment system 200 may store and execute the data and instructions of one or more applications, modules or other software. One or more processors 202 may implement functionality and/or execute instructions within infotainment system 200. For example, processors 202 of infotainment system 200 may receive and execute instructions stored by storage device 206 that provide the functionality of application 208, UI module 210, refresh limit module 214, and OS 212. These instructions executed by processors 202 may cause infotainment system 200 to store and/or modify information, within storage device 206 during program execution. In general, processors 202 may execute instructions within storage device 206 to perform one or more operations of infotainment system 200, such as the various functions described herein.

One or more input components 220 of infotainment system 200 may receive input. Examples of input are tactile, audio, and video input. In some examples, input components 220 may include functionality of display 104 of FIG. 1. Input components 220 of infotainment system 200, for example, may include one or more of a presence-sensitive input device (e.g., a touch sensitive screen or pad, a presence-sensitive display), mouse, keyboard, button, rotary-translational knob, thumbpad, d-pad, switch, voice responsive system, video camera, microphone or any other type of device for detecting input from a human or machine. In some examples, input components 220 may include one or more sensor components, one or more location sensors (e.g., Wi-Fi components, cellular components, etc.), one or more temperature sensors, one or more movement sensors (e.g., accelerometers, gyros, etc.), one or more pressure sensors (e.g., barometer), one or more ambient light sensors, and one or more other sensors (e.g., microphone, camera, infrared proximity sensor, hygrometer, etc.). Other sensors may include a heart rate sensor, magnetometer, glucose sensor, hygrometer sensor, olfactory sensor, compass sensor, step counter sensor, to name a few other non-limiting examples.

One or more output components 222 of infotainment system 200 may generate output. Examples of output are tactile, audio, and video output. In some examples, output components 222 may include functionality of display 104 of FIG. 1. Output components 222 of infotainment system 200, in one example, include a presence-sensitive screen, sound card, video graphics adapter card, speaker, cathode ray tube (CRT) monitor, liquid crystal display (LCD), or any other type of device for generating output to a human or machine. Output components 222 may include display devices such as liquid crystal display (LCD), Light-Emitting Diode (LED) or any other type of device for generating tactile, audio, and/or visual output.

One or more communication units 224 of infotainment system 200 may communicate with external devices by transmitting and/or receiving data. For example, infotainment system 200 may use communication units 224 to transmit and/or receive radio signals on a radio network such as a cellular radio network. In some examples, communication units 224 may transmit and/or receive satellite signals on a satellite network such as a Global Positioning System (GPS) network or a Global Navigation Satellite System (GLONASS) network. Examples of communication units 224 include a network interface card (e.g., an Ethernet card), an optical transceiver, a radio frequency transceiver, a GPS receiver, or any other type of device that can send and/or receive information. Other examples of communication units 224 may include Bluetooth®, GPS, 3G, 4G, and Wi-Fi® radios found in mobile devices as well as Universal Serial Bus (USB) controllers and the like.

In some examples, display 204 of infotainment system 200 may include functionality of input components 220 and/or output components 222. In the example of FIG. 2, display 204 may include a presence-sensitive input component 228, such as a presence-sensitive screen or touch-sensitive screen. In some examples, presence-sensitive input component 228 may detect an object at and/or near the presence-sensitive input device. As one example range, presence-sensitive input component 228 may detect an object, such as a finger or stylus that is within two inches or less of presence-sensitive input component 228. Presence-sensitive input component 228 may determine a location (e.g., an (x,y) coordinate) of the presence-sensitive input device at which the object was detected. In another example range, presence-sensitive input component 228 may detect an object six inches or less from presence-sensitive input component 228 and other ranges are also possible. Presence-sensitive input component 228 may determine the location of presence-sensitive input component 228 selected by a user's finger using capacitive, inductive, and/or optical recognition techniques.

In some examples, display 204 may also provide output to a user using tactile, audio, or video stimuli as described with respect to output components 222. For instance, display 204 may include display component 230 that presents a graphical user interface. Display component 230 may be any type of output device that provides visual output, such as described with respect to output components 222. Display 204 may, in some examples, be an external component that shares a data path with other components of infotainment system 200 for transmitting and/or receiving input and output. For instance, display 204 may be a built-in component of a head-unit (such as housing that includes infotainment system 200), located within and physically connected to the external packaging of infotainment system 200. In another example, display 204 may be an external component of infotainment system 200 located outside and physically separated from the packaging of infotainment system 200 (e.g., a monitor, a projector, etc. that shares a wired and/or wireless data path with a tablet computer).

One or more storage device 206 within infotainment system 200 may store information for processing during operation of infotainment system 200. In some examples, one or more of storage device 206 are temporary memories, meaning that a primary purpose of the one or more storage devices is not long-term storage. Storage device 206 on infotainment system 200 may be configured for short-term storage of information as volatile memory and therefore not retain stored contents if deactivated. Examples of volatile memories include random access memories (RAM), dynamic random access memories (DRAM), static random access memories (SRAM), and other forms of volatile memories known in the art.

Storage device 206, in some examples, also include one or more computer-readable storage media. Storage device 206 may be configured to store larger amounts of information than volatile memory. Storage device 206 may further be configured for long-term storage of information as non-volatile memory space and retain information after activate/off cycles. Examples of non-volatile memories include magnetic hard discs, optical discs, flash memories, or forms of electrically programmable memories (EPROM) or electrically erasable and programmable (EEPROM) memories. Storage device 206 may store program instructions and/or data associated with infotainment system 200.

OS 212, in some examples, controls the operation of components of infotainment system 200. For example, OS 212, in one example, facilitates the communication of application 208, UI module 210, refresh limit module 214, and step limit module 216 with processors 202, storage device 206, input components 220, output components 222, communication units 224, and display 204.

Refresh limit module 214 may include functionality to manage an attention level of an operator of vehicle 10 that the operator directs towards a task of driving vehicle 10 by pacing content interaction with infotainment system 200. As shown in the example of FIG. 2, refresh limit module 214 may include a vehicle state detection module 234, and an input detection module 232.

Input detection module 232 of refresh limit module 214 may be configured to receive indications of user inputs received by one or more of input components 220, 230. The user inputs may include, for example, tactile, audio, or video inputs such as touch inputs, voice commands, and/or non-touch gesture commands provided by a user. For example, input detection module 232 may receive indications of user inputs from presence-sensitive input component 228, in addition or alternative to receiving indications of user inputs such as voice commands detected by a microphone or non-touch gesture commands detected by a video camera. The input components may include components of infotainment system 200, mechanical input components of vehicle 10, a separate in-vehicle navigation system, etc.

Based on whether a request to refresh a GUI from application 208 is application-initiated (not user-initiated), refresh limit module 214 may initiate a refresh limit period for application 208. For example, responsive to input detection module 232 not detecting a user input that caused application 208 to send the request, refresh limit module 214 may initiate a refresh limit period (e.g., as described above in FIG. 1). Responsive to input detection module 232 detecting a user input that caused application 208 to send the request, refresh limit module 214 may not initiate a refresh limit period.

Additionally or alternatively, vehicle state detection module 234 may receive information regarding a state of vehicle 10. Vehicle states may include, for example whether vehicle 10 is parked or driving. In some examples, vehicle states may include a speed at which vehicle 10 is moving (including whether vehicle 10 is moving or stationary), a gear that vehicle 10 is in (e.g., whether vehicle 10 is in a “park” or a “drive” gear), etc. Vehicle state detection module 234 can detect the state of vehicle 10 based on, for example, one or more of indications of vehicle states received from sensors of infotainment system 200, indications of vehicle states received from a vehicle computing device integrated within vehicle 10, indications of vehicle states received from sensors associated with components of vehicle 10, indications of vehicle states received from OS 212, etc.

Vehicle state detection module 234 may provide real-time information about the state of vehicle 10 to refresh limit module 214. Based on the state of vehicle 10, refresh limit module 214 may initiate a refresh limit period for application 208. For example, responsive to vehicle state detection module 234 detecting that vehicle 10 is in a driving state, refresh limit module 214 may initiate a refresh limit period (e.g., as described above in FIG. 1). Responsive to vehicle state detection module 234 detecting that vehicle 10 is in a driving state, refresh limit module 214 may not initiate a refresh limit period.

In general, when the GUI of application 208 refreshes, only a relatively small portion of the GUI may be updated, such that a relatively large portion of the GUI remains the same. However, in some examples, the GUI of application 208 may change dramatically, such as when application 208 changes from one page to another page (e.g., that includes relevant controls, information, visuals, etc., specific to that particular page). Dramatic changes in a GUI can potentially be more distracting for a driver. For example, GUI changes that involve sudden shifts in layout, colors, or graphical elements can have an increased likelihood of diverting the driver's attention from the road, potentially impairing the driver's ability to perceive and respond to driving situations.

Accordingly, in some examples, infotainment system 200 may include a step limit module 216. As used herein, a step may refer to a dramatic change to a GUI of application 208, such as a shift in layout, colors, graphical elements, etc. For example, changing the layout of a GUI, changing one or more headers of a GUI, etc., may constitute a step. By contrast, updating a notification indicating a new number of unread messages, updating a list to show new results, etc., may not constitute a step. These examples are not limiting, and other examples of changes that are steps and not steps are contemplated by this disclosure. In any case, one or more of refresh limit module 214 or step limit module 216 may determine whether the request includes a step or not.

Infotainment system 200 may treat requests from application 208 that include steps and requests from application 208 that do not include steps differently. For example, responsive to the request to refresh the GUI from application 208 not including a step (e.g., the request does not include changing the layout of the GUI, changing a header of the GUI, etc.), refresh limit module 214 may initiate a refresh limit period as described above. On the other hand, responsive to the request including a step (e.g., the request includes changing the layout of the GUI, changing a header of the GUI, etc.), step limit module 216 may determine whether a step counter satisfies a step counter threshold (e.g., the step counter is less than the step counter threshold). Responsive to step limit module 216 determining that the step counter satisfies a step counter threshold, UI module 210 may process the request, and step limit module 216 may increment the step counter. Responsive to step limit module 216 determining that the step counter does not satisfy the step counter threshold (e.g., the step counter is equal to the step counter threshold), step limit module 216 may delay processing of the request until the vehicle is in a stationary state.

In the example where the step counter does not satisfy the step counter threshold, UI module 210 may output an indication that interaction with application 208 is suspended until vehicle 10 is parked. For example, UI module 210 may provide a notification, such as via one of output components 222 and/or display component 230. The notification may be one or more of audible, tactile, and visual, for example. In some examples, UI module 210 to change a presentation of the GUI of application 208. For example, display component 230 may display one or more graphical elements (such as a menu structure) as semi-transparent or greyed-out. These or other display changes may indicate that the user interface elements are non-functional (e.g., until vehicle 10 is parked).

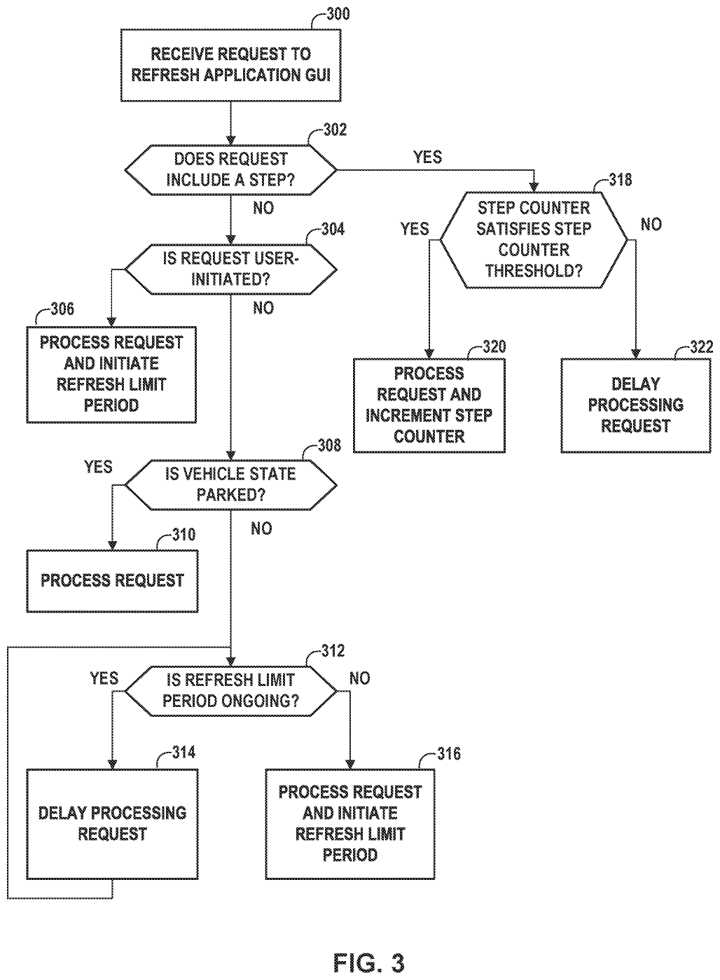

FIG. 3 is a flow diagram illustrating example operation for to pacing a rate at which a GUI of a vehicle application refreshes, in accordance with one or more techniques of the present disclosure. The techniques of FIG. 3 may be performed by one or more processors of a computing system, such as infotainment system 100 illustrated in FIG. 1 and infotainment system 200 of FIG. 2. For purposes of illustration, the techniques of FIG. 3 are described within the context of infotainment system 200 of FIG. 2, although infotainment systems other than infotainment system 200 may perform the techniques of FIG. 3.

While vehicle 10 is being used, infotainment system 200 may execute application 208. While application 208 is executing, refresh limit module 214 may receive a request to refresh at least a portion of the GUI from application 208 (300). In general, refreshing the GUI may allow application 208 to provide the most accurate, up-to-date information. For example, refreshing the GUI may display new content (e.g., messages, stock prices, the weather, etc.), status updates, error messages, notifications, etc.

Infotainment system 200 may, in some examples, determine whether the request to refresh the GUI from application 208 includes a step (e.g., a dramatic change to the GUI that may be relatively more distracting to a driver) (302). Any one or more components of infotainment system 200, such as refresh limit module 214 or step limit module 216, may determine whether the request includes a step. Responsive to determining that the request does not include a step (“NO” branch of block 302), refresh limit module 312 may, in some examples, determine whether the request is user-initiated (304). Refresh limit module 312 may determine whether the request is user-initiated based on an indication from input detection module 232. Responsive to refresh limit module 214 determining that the request is user-initiated (“YES” branch of block 304), UI module 210 may process the request, and refresh limit module 214 may initiate a refresh limit period (306).

Responsive to refresh limit module 214 determining that the request is not user-initiated (“NO” branch of block 304), refresh limit module 214 may, in some examples, determine whether the state of vehicle 10 is parked (308). UI module 210 may determine the state of vehicle 10 based on an indication from vehicle state detection module 234. Responsive to refresh limit module 214 determining that the state of vehicle 10 is parked (“YES” branch of block 308), UI module 210 may process the request (310). Refresh limit module 214 may not initiate a refresh limit period while the state of vehicle 10 is parked.

Responsive to determining that the state of vehicle 10 is not parked (“NO” branch of block 308), refresh limit module 214 may determine whether refresh limit module 214 received the request during a refresh limit period. In other words, refresh limit module 214 may determine whether the request is in queue for processing while a refresh limit period is ongoing (312). Responsive to determining that the refresh limit period is ongoing (“YES” branch of block 312), refresh limit module 214 may delay processing of the request until the refresh limit period expires (314). Responsive to determining that the refresh limit period has expired and is therefore not ongoing (“NO” branch of block 312), UI module 210 may process the request, and refresh limit module 214 may initiate the refresh limit period (316).

In examples where infotainment system determines whether the request includes a step, responsive to determining that the request includes a step (“YES” branch of block 302), step limit module 216 may determine whether a step counter satisfies a step counter threshold (318). Responsive to step limit module 216 determining that the step counter satisfies a step counter threshold (“YES” branch of block 318), UI module 210 may process the request, and step limit module 216 may increment the step counter (320). Responsive to step limit module 216 determining that the step counter does not satisfy the step counter threshold (“NO” branch of block 318), step limit module 216 may delay processing of the request until the vehicle is in a stationary state (322).

The following numbered examples may illustrate one or more aspects of the disclosure:

Example 1: A method includes receiving, by one or more processors of an infotainment system of a vehicle and from an application executing at the infotainment system, a request to refresh a graphical user interface of the application being displayed by a display of the infotainment system; determining, by the one or more processors, whether the one or more processors received the request during a refresh limit period; responsive to determining that the one or more processors received the request during a refresh limit period, delaying, by the one or more processors, processing of the request; and responsive to expiration of the refresh limit period: processing, by the one or more processors, the request; and responsive to processing the request, initiating, by the one or more processors, the refresh limit period.

Example 2: The method of example 1, further includes responsive to determining that that the one or more processors received the request outside of the refresh limit period: processing, by the one or more processors, the request; and responsive to processing the request, initiating, by the one or more processors, the refresh limit period.

Example 3: The method of any of examples 1 and 2, further includes determining, by the one or more processors, whether the request is user-initiated, wherein delaying processing of the request is further in response to determining that the request is not user-initiated.

Example 4: The method of example 3, further includes responsive to determining that that the request is user-initiated: processing, by the one or more processors, the request; and responsive to processing the request, initiating, by the one or more processors, the refresh limit period.

Example 5: The method of any of examples 1 through 4, further includes determining, by the one or more processors, whether the vehicle is in a stationary state, and wherein delaying processing of the request is further in response to determining that the vehicle is not in the stationary state.

Example 6: The method of example 5, further includes responsive to determining that that the vehicle is in the stationary state: processing, by the one or more processors, the request.

Example 7: The method of any of examples 1 through 6, wherein the request to refresh the graphical user interface does not include changing a layout of the graphical user interface.

Example 8: The method of any of examples 1 through 7, wherein the request to refresh the graphical user interface does not include changing one or more headers of the graphical user interface.

Example 9: The method of any of examples 1 through 8, further includes determining, by the one or more processors, whether the request includes one or more of changing a layout of the graphical user interface or changing one or more headers of the graphical user interface, wherein delaying processing of the request is further in response to determining that the request does not include one or more of changing the layout of the graphical user interface or changing one or more headers of the graphical user interface; and responsive to determining that the request includes one or more of changing the layout of the graphical user interface or changing one or more headers of the graphical user interface: responsive to determining that a step counter satisfies a step counter threshold: processing, by the one or more processors, the request; and incrementing the step counter; and responsive to determining that the step counter does not satisfy the step counter threshold, delaying, by the one or more processors, processing of the request until the vehicle is in a stationary state.

Example 10: The method of any of examples 1 through 9, wherein the refresh limit period is ten seconds.

Example 11: An infotainment system of a vehicle, the infotainment system includes one or more processors; and a memory that stores instructions that, when executed by the one or more processors, cause the one or more processors to: receive, from an application executing at the infotainment system, a request to refresh a graphical user interface of the application being displayed by a display of the infotainment system; determine whether the one or more processors received the request during a refresh limit period; responsive to determining that the one or more processors received the request during a refresh limit period, delay processing of the request; and responsive to expiration of the refresh limit period: process the request; and responsive to processing the request, initiate the refresh limit period.

Example 12: The infotainment system of example 11, wherein the one or more processors are further configured to: responsive to determining that the one or more processors received the request outside of the refresh limit period: process the request; and responsive to processing the request, initiate the refresh limit period.

Example 13: The infotainment system of any of examples 11 and 12, wherein the one or more processors are further configured to: determine whether the request is user-initiated, wherein the one or more processors are configured to delay processing of the request further in response to determining that the request is not user-initiated.

Example 14: The infotainment system of example 13, wherein the one or more processors are further configured to: responsive to determining that that the request is user-initiated: process the request; and responsive to processing the request, initiate the refresh limit period.

Example 15: The infotainment system of any of examples 11 through 14, wherein the one or more processors are further configured to: determine whether the vehicle is in a stationary state, wherein the one or more processors are configured to delay processing of the request further in response to determining that the vehicle is not in the stationary state.

Example 16: The infotainment system of example 15, wherein the one or more processors are further configured to: responsive to determining that that the vehicle is in the stationary state: process the request.

Example 17: The infotainment system of any of examples 11 through 16, wherein the request to refresh the graphical user interface does not include changing a layout of the graphical user interface.

Example 18: The infotainment system of any of examples 11 through 17, wherein the request to refresh the graphical user interface does not include changing one or more headers of the graphical user interface.

Example 19: The infotainment system of any of examples 11 through 18, wherein the one or more processors are further configured to: determine whether the request includes one or more of changing a layout of the graphical user interface or changing one or more headers of the graphical user interface, wherein the one or more processors are configured to delay processing of the request further in response to determining that the request does not include one or more of changing the layout of the graphical user interface or changing one or more headers of the graphical user interface; and responsive to determining that the request includes one or more of changing the layout of the graphical user interface or changing one or more headers of the graphical user interface: responsive to determining that a step counter satisfies a step counter threshold: process the request; and increment the step counter; and responsive to determining that the step counter does not satisfy the step counter threshold, delay processing of the request until the vehicle is in a stationary state.

Example 20: The infotainment system of any of examples 11 through 19, wherein the refresh limit period is ten seconds.

Example 21: A non-transitory computer-readable storage medium includes instructions that, when executed, cause one or more processors of an infotainment system to: receive, from an application executing at the infotainment system, a request to refresh a graphical user interface of the application being displayed by a display of the infotainment system; determine whether the one or more processors received the request during a refresh limit period; responsive to determining that the one or more processors received the request during a refresh limit period, delay processing of the request; and responsive to expiration of the refresh limit period: process the request; and responsive to processing the request, initiate the refresh limit period.

Example 22: The non-transitory computer-readable storage medium of example 21, wherein the instructions further cause the one or more processors to: responsive to determining that the one or more processors received the request outside of the refresh limit period: process the request; and responsive to processing the request, initiate the refresh limit period.

Example 23: The non-transitory computer-readable storage medium of any of examples 21 and 22, wherein the one or more processors are further configured to: determine whether the request is user-initiated, wherein the one or more processors are configured to delay processing of the request further in response to determining that the request is not user-initiated.

Example 24: The non-transitory computer-readable storage medium of example 23, wherein the one or more processors are further configured to: responsive to determining that that the request is user-initiated: process the request; and responsive to processing the request, initiate the refresh limit period.

Example 25: The non-transitory computer-readable storage medium of any of examples 21 through 24, wherein the one or more processors are further configured to: determine whether the vehicle is in a stationary state, wherein the one or more processors are configured to delay processing of the request further in response to determining that the vehicle is not in the stationary state.

Example 26: The non-transitory computer-readable storage medium of example 25, wherein the one or more processors are further configured to: responsive to determining that that the vehicle is in the stationary state: process the request.

Example 27: The non-transitory computer-readable storage medium of any of examples 21 through 26, wherein the request to refresh the graphical user interface does not include changing a layout of the graphical user interface.

Example 28: The non-transitory computer-readable storage medium of any of examples 21 through 27, wherein the request to refresh the graphical user interface does not include changing one or more headers of the graphical user interface.

Example 29: The non-transitory computer-readable storage medium of any of examples 21 through 28, wherein the one or more processors are further configured to: determine whether the request includes one or more of changing a layout of the graphical user interface or changing one or more headers of the graphical user interface, wherein the one or more processors are configured to delay processing of the request further in response to determining that the request does not include one or more of changing the layout of the graphical user interface or changing one or more headers of the graphical user interface; and responsive to determining that the request includes one or more of changing the layout of the graphical user interface or changing one or more headers of the graphical user interface: responsive to determining that a step counter satisfies a step counter threshold: process the request; and increment the step counter; and responsive to determining that the step counter does not satisfy the step counter threshold, delay processing of the request until the vehicle is in a stationary state.

Example 30: The non-transitory computer-readable storage medium of any of examples 21 through 29, wherein the refresh limit period is ten seconds.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “one or more processors” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various examples of the invention have been described. These and other examples are within the scope of the following claims.

What is claimed is:

1. A method comprising:
receiving, by one or more processors of an infotainment system of a vehicle and from an application executing at the infotainment system, a request to refresh a graphical user interface of the application being displayed by a display of the infotainment system;
determining, by the one or more processors, whether the one or more processors received the request during a refresh limit period;
responsive to determining that the one or more processors received the request during a refresh limit period, delaying, by the one or more processors, processing of the request; and
responsive to expiration of the refresh limit period:
processing, by the one or more processors, the request; and
responsive to processing the request, initiating, by the one or more processors, the refresh limit period.

2. The method of claim 1, further comprising:
responsive to determining that that the one or more processors received the request outside of the refresh limit period:
processing, by the one or more processors, the request; and
responsive to processing the request, initiating, by the one or more processors, the refresh limit period.

3. The method of claim 1, further comprising:
determining, by the one or more processors, whether the request is user-initiated,
wherein delaying processing of the request is further in response to determining that the request is not user-initiated.

4. The method of claim 3, further comprising:
responsive to determining that that the request is user-initiated:
processing, by the one or more processors, the request; and
responsive to processing the request, initiating, by the one or more processors, the refresh limit period.

5. The method of claim 1, further comprising:
determining, by the one or more processors, whether the vehicle is in a stationary state, and wherein delaying processing of the request is further in response to determining that the vehicle is not in the stationary state.

6. The method of claim 5, further comprising:
responsive to determining that that the vehicle is in the stationary state:
processing, by the one or more processors, the request.

7. The method of claim 1, wherein the request to refresh the graphical user interface does not include changing a layout of the graphical user interface.

8. The method of claim 1, wherein the request to refresh the graphical user interface does not include changing one or more headers of the graphical user interface.

9. The method of claim 1, further comprising:
determining, by the one or more processors, whether the request includes one or more of changing a layout of the graphical user interface or changing one or more headers of the graphical user interface, wherein delaying processing of the request is further in response to determining that the request does not include one or more of changing the layout of the graphical user interface or changing one or more headers of the graphical user interface; and
responsive to determining that the request includes one or more of changing the layout of the graphical user interface or changing one or more headers of the graphical user interface:
responsive to determining that a step counter satisfies a step counter threshold:
processing, by the one or more processors, the request; and
incrementing the step counter; and
responsive to determining that the step counter does not satisfy the step counter threshold, delaying, by the one or more processors, processing of the request until the vehicle is in a stationary state.

10. The method of claim 1, wherein the refresh limit period is ten seconds.

11. An infotainment system of a vehicle, the infotainment system comprising:
one or more processors; and
a memory that stores instructions that, when executed by the one or more processors, cause the one or more processors to:
receive, from an application executing at the infotainment system, a request to refresh a graphical user interface of the application being displayed by a display of the infotainment system;
determine whether the one or more processors received the request during a refresh limit period;
responsive to determining that the one or more processors received the request during a refresh limit period, delay processing of the request; and
responsive to expiration of the refresh limit period:
process the request; and
responsive to processing the request, initiate the refresh limit period.

12. The infotainment system of claim 11, wherein the one or more processors are further configured to:
responsive to determining that the one or more processors received the request outside of the refresh limit period:
process the request; and
responsive to processing the request, initiate the refresh limit period.

13. The infotainment system of claim 11, wherein the one or more processors are further configured to:
determine whether the request is user-initiated,
wherein the one or more processors are configured to delay processing of the request further in response to determining that the request is not user-initiated.

14. The infotainment system of claim 13, wherein the one or more processors are further configured to:
responsive to determining that that the request is user-initiated:
process the request; and
responsive to processing the request, initiate the refresh limit period.

15. The infotainment system of claim 11, wherein the one or more processors are further configured to:
determine whether the vehicle is in a stationary state, wherein the one or more processors are configured to delay processing of the request further in response to determining that the vehicle is not in the stationary state.

16. The infotainment system of claim 15, wherein the one or more processors are further configured to:
responsive to determining that that the vehicle is in the stationary state:
process the request.

17. The infotainment system of claim 11, wherein the request to refresh the graphical user interface does not include changing a layout of the graphical user interface.

18. The infotainment system of claim 11, wherein the request to refresh the graphical user interface does not include changing one or more headers of the graphical user interface.

19. A non-transitory computer-readable storage medium comprising instructions that, when executed, cause one or more processors of an infotainment system to:
receive, from an application executing at the infotainment system, a request to refresh a graphical user interface of the application being displayed by a display of the infotainment system;
determine whether the one or more processors received the request during a refresh limit period;
responsive to determining that the one or more processors received the request during a refresh limit period, delay processing of the request; and
responsive to expiration of the refresh limit period:
process the request; and
responsive to processing the request, initiate the refresh limit period.

20. The non-transitory computer-readable storage medium of claim 19, wherein the instructions further cause the one or more processors to:
responsive to determining that the one or more processors received the request outside of the refresh limit period:
process the request; and
responsive to processing the request, initiate the refresh limit period.
